(19) United States
(12) Patent Application Publication
(10) Pub. No.: US 2015/0029365 A1
(43) Pub. Date: Jan. 29, 2015

(54) UNIT PIXEL OF IMAGE SENSOR AND IMAGE SENSOR HAVING THE SAME

(71) Applicant: SAMSUNG ELECTRONICS CO., LTD., Suwon-si (KR)

(72) Inventors: Gwi-Deok Ryan LEE, Suwon-si (KR); Hiroshige GOTO, Suwon-si (KR); Sang-Chul SUL, Suwon-si (KR); Myung-Won LEE, Hwaseong-si (KR); Masaru ISHII, Hwaseong-si (KR)

(73) Assignee: SAMSUNG ELECTRONICS CO., LTD., Suwon-si (KR)

(21) Appl. No.: 14/340,703

(22) Filed: Jul. 25, 2014

(30) Foreign Application Priority Data
Jul. 25, 2013 (KR) 10-2013-0088063

(51) Int. Cl. H04N 9/04

(52) U.S. Cl. CPC H04N 9/045
USPC 348/272

(57) ABSTRACT

A unit pixel is provided. The unit pixel includes photoelectric converters stacked on each other and configured to generate photo-charges in response to light signals within respective wavelength ranges and provide the photo-charges to respective storage nodes; memories configured to concurrently receive and store the photo-charges from the respective storage nodes in response to a common control signal; and a signal generator that generates analog signals based on the photo-charges stored in the memories, respectively.

### CROSS-REFERENCE TO RELATED APPLICATION

This application claims priority from to Korean Patent Application No. 10-2013-0088063, filed on Jul. 25, 2013 in the Korean Intellectual Property Office, the contents of which are herein incorporated by reference in their entirety.

### BACKGROUND

1. Technical Field

Apparatuses, devices, and articles of manufacture consistent with the present disclosure relate to an image sensor, and more particularly to an image sensor having a multi-layer structure.

2. Description of the Related Art

Recently, a multi-layer image sensor is used for a high quality image. Each unit pixel included in the multi-layer image sensor generates a plurality of color signals.

However, if the plurality of color signals generated from a unit pixel represent image information at different times, quality of an image generated from the image sensor may be degraded.

### SUMMARY

One or more exemplary embodiments provide a unit pixel of an image sensor that generates a plurality of color signals representing image information at the same time.

One or more exemplary embodiments also provide an image sensor including the unit pixel.

According to an aspect of an exemplary embodiment, there is provided a unit pixel of an image sensor that includes first through n-th photoelectric converters stacked on each other and configured to generate photo-charges in response to light signals within respective wavelength ranges and provide the photo-charges to first through n-th storage nodes, respectively, n being an integer equal to or greater than two; first through n-th memories configured to concurrently receive and store the photo-charges from the first through n-th storage nodes, respectively, in response to a common control signal; and a signal generator configured to generate first through n-th analog signals consecutively based on the photo-charges stored in the first through n-th memories, respectively.

The first through n-th memories and the signal generator may be formed on a substrate and the first through n-th photoelectric converters may be formed above the substrate.

Each of the first through n-th photoelectric converters may include an organic photodiode having an organic material.

N may be equal to or greater than three, and the first photoelectric converter may generate the photo-charges in response to a light signal within a wavelength range of blue color and provide the photo-charges to the first storage node, the second photoelectric converter may generate the photo-charges in response to a light signal within a wavelength range of green color and provide the photo-charges to the second storage node and the third photoelectric converter may generate the photo-charges in response to a light signal within a wavelength range of red color and provide the photo-charges to the third storage node.

N may be equal to or greater than four, and the fourth photoelectric converter may generate the photo-charges in response to a light signal within a wavelength range of infrared rays and provide the photo-charges to the fourth storage node.

A k-th memory may include a k-th storage transistor having a source coupled to a k-th storage node, a drain corresponding to a k-th memory node and a gate receiving the common control signal, where k is a positive integer equal to or smaller than n.

The first through n-th memories may include first through n-th storage transistors, respectively, that may turn on at a same time in response to the common control signal to concurrently transfer the photo-charges stored in the first through n-th storage nodes to first through n-th memories, respectively.

The signal generator may include first through n-th transmission transistors configured to transfer the photo-charges stored in the first through n-th memories, respectively, to a floating diffusion area in response to first through n-th transmission control signals, respectively, a reset transistor including a source coupled to the floating diffusion area, a drain coupled to a supply voltage and a gate receiving a reset control signal, a driving transistor including a source, a drain coupled to the supply voltage and a gate coupled to the floating diffusion area, and a row selection transistor including a drain coupled to the source of the driving transistor, a gate receiving a row selection signal and a source outputting the first through n-th analog signals.

The k-th transmission transistor may include a source coupled to a k-th memory, a drain coupled to the floating diffusion area and a gate receiving a k-th transmission control signal.

The first through n-th transmission control signals may be activated consecutively.

The reset control signal and each of the first through n-th transmission control signals may be activated alternately.

According to an aspect of another exemplary embodiment, there is provided an image sensor that includes a pixel array, the unit pixel including a pixel array including a plurality of unit pixels arranged in rows and columns, each of the plurality of unit pixels generating first through n-th analog signals consecutively by detecting light signals within different wavelength ranges from a same start time to a same end time; an analog-digital converter configured to convert the first through n-th analog signals to first through n-th digital signals, respectively; and a controller configured to control operations of the pixel array and the analog-digital converter.

Each of the plurality of unit pixels may include first through n-th photoelectric converters stacked on each other, each of which generating photo-charges in response to a light signal within a wavelength range and providing the photo-charges to first through n-th storage nodes, respectively, first through n-th memories configured to concurrently receive and store the photo-charges from the first through n-th storage nodes, respectively, in response to a common control signal, and a signal generator configured to generate the first through n-th analog signals consecutively based on the photo-charges stored in the first through n-th memories, respectively.

The signal generator may include first through n-th transmission transistors configured to transfer the photo-charges stored in the first through n-th memories to a floating diffusion area in response to first through n-th transmission control signals, respectively, a reset transistor including a source coupled to the floating diffusion area, a drain coupled to a supply voltage and a gate receiving a reset control signal, a driving transistor including a source, a drain coupled to the supply voltage and a gate coupled to the floating diffusion area, and a row selection transistor including a drain coupled to the source of the driving transistor, a gate receiving a row selection signal and a source outputting the first through n-th analog signals.

The controller may activate the common control signal, the first through n-th transmission control signals and the reset control signal in a reset phase, deactivate the common control signal in a detection phase, activate the common control signal and deactivates the first through n-th transmission control signals in a memory storage phase, and activate each of the first through n-th transmission control signals and the reset control signal alternately in a read phase.

According to an aspect of another exemplary embodiment, there is provided a unit pixel comprising a plurality of photoelectric converters, each of the photoelectric converters generating photo-charges in response to a light signal within a different wavelength range and providing the generated photo-charges to a plurality of storage nodes, respectively; a plurality of memories configured to concurrently receive and store the photo-charges from the plurality of storage nodes, respectively, in response to a common control signal; and a signal generator configured to generate a plurality of analog signals based on the photo-charges stored in the plurality of memories, respectively.

### BRIEF DESCRIPTION OF THE DRAWINGS

Illustrative, non-limiting exemplary embodiments will be more clearly understood from the following detailed description in conjunction with the accompanying drawings in which:

FIG. 1 is a block diagram illustrating a unit pixel of an image sensor according to an exemplary embodiment;

FIG. 2 is a diagram illustrating an example of photoelectric converters included in the unit pixel of FIG. 1, according to an exemplary embodiment;

FIG. 3 is a diagram illustrating another example of photoelectric converters included in the unit pixel of FIG. 1, according to an exemplary embodiment;

FIG. 4 is a circuit diagram illustrating an example of a signal generator included in a unit pixel of FIG. 1;

FIG. 5 is a circuit diagram illustrating an example of a memory included in the unit pixel of FIG. 1;

FIG. 6 is a plane diagram illustrating an example of a substrate on which a signal generator and a memory included in the unit pixel of FIG. 5 are formed;

FIG. 7 is a cross-sectional view of the substrate of FIG. 6 taken along line A-A′;

FIG. 8 is another cross-sectional view of the substrate of FIG. 6 taken along line A-A′;

FIG. 9 is a block diagram illustrating an image sensor according to an exemplary embodiment;

FIG. 10 is a timing diagram for describing an operation of the image sensor of FIG. 9;

FIG. 11 is a block diagram illustrating a computing system including an image sensor according to an exemplary embodiment; and

FIG. 12 is a block diagram illustrating an example of an interface used in the computing system of FIG. 11.

### DETAILED DESCRIPTION

Various exemplary embodiments will be described more fully with reference to the accompanying drawings, in which some example embodiments are shown. The present inventive concept may, however, be embodied in many different forms and should not be construed as limited to the exemplary embodiments set forth herein. Rather, these exemplary embodiments are provided so that this disclosure will be thorough and complete, and will fully convey the scope of the present inventive concept to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a block diagram illustrating a unit pixel of an image sensor according to an exemplary embodiment.

Referring to FIG. 1, a unit pixel 10 includes first through n-th photoelectric converters 100-1, 100-2, . . . , 100-n, first through n-th memories (memory 1) 200-1, (memory 2) 200-2, . . . , (memory n) 200-n and a signal generator 300. Here, n represents an integer equal to or greater than two.

The first through n-th photoelectric converters 100-1, 100-2, . . . , 100-n are stacked on each other. Each of the first through n-th photoelectric converters 100-1, 100-2, . . . , 100-n generates photo-charges in response to a light signal within a respective wavelength range and provides the photo-charges to first through n-th storage nodes SN1, SN2, . . . , SNn, respectively. Therefore, the photo-charges generated from the first through n-th photoelectric converters 100-1, 100-2, . . . , 100-n may be accumulated in the first through n-th storage nodes SN1, SN2, . . . , SNn, respectively.

The first through n-th memories 200-1, 200-2, . . . , 200-n concurrently receive and store the photo-charges from the first through n-th storage nodes SN1, SN2, . . . , SNn, respectively, in response to a common control signal CCS. For example, the first through n-th memories 200-1, 200-2, . . . , 200-n may be turned off such that the photo-charges generated from the first through n-th photoelectric converters 100-1, 100-2, . . . , 100-n may be accumulated in the first through n-th storage nodes SN1, SN2, . . . , SNn, respectively, when the common control signal CCS has a first logic level, and the first through n-th memories 200-1, 200-2, . . . , 200-n may be turned on at the same time to receive and store the photo-charges accumulated in the first through n-th storage nodes SN1, SN2, . . . , SNn, respectively, when the common control signal CCS has a second logic level. The first logic level may be a logic low level and the second logic level may be a logic high level.

The signal generator 300 may generate first through n-th analog signals AS1, AS2, . . . , ASn consecutively based on the photo-charges stored in the first through n-th memories 200-1, 200-2, . . . , 200-n, respectively.

In some example embodiments, the first through n-th storage nodes SN1, SN2, . . . , SNn, the first through n-th memories 200-1, 200-2, . . . , 200-n and the signal generator 300 may be formed on a substrate 101 and the first through n-th photoelectric converters 100-1, 100-2, . . . , 100-n may be formed above the substrate 101. Each of the first through n-th photoelectric converters 100-1, 100-2, . . . , 100-n may include an organic photodiode having an organic material. In this case, the organic photodiodes included in the first through n-th photoelectric converters 100-1, 100-2, . . . , 100-n may include different organic materials that absorb light signals within different wavelength ranges. Therefore, each of the first through n-th photoelectric converters 100-1, 100-2, . . . , 100-n may generate the photo-charges in response to a light signal within a respective wavelength range determined by the organic material included in the organic photodiode.

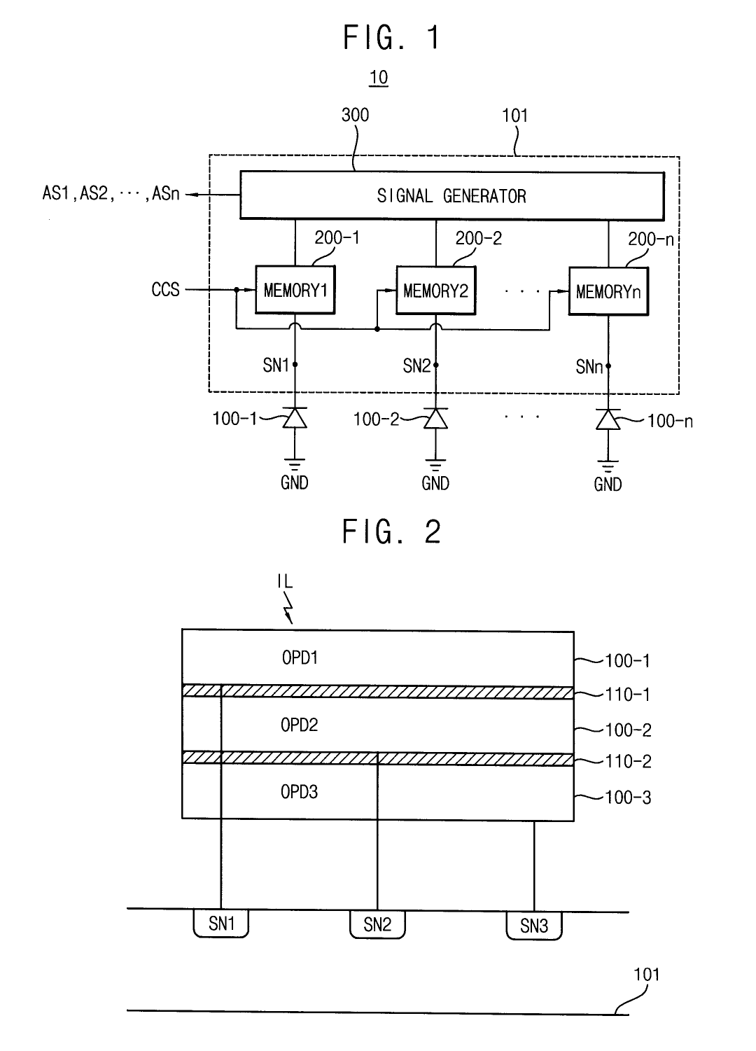

FIG. 2 is a diagram illustrating an example of photoelectric converters included in the unit pixel of FIG. 1, according to an exemplary embodiment.

Referring to FIGS. 1 and 2, the unit pixel 10 may include first through third photoelectric converters 100-1, 100-2, 100-3 stacked on each other above the substrate 101 and first through third storage nodes SN1, SN2, SN3 formed on the substrate 101.

The first through third photoelectric converters 100-1, 100-2, 100-3 may be electrically connected to the first through third storage nodes SN1, SN2, SN3, respectively, through wirings.

A first insulation layer 110-1 may be formed between the first photoelectric converter 100-1 and the second photoelectric converter 100-2, and a second insulation layer 110-2 may be formed between the second photoelectric converter 100-2 and the third photoelectric converter 100-3. The first insulation layer 110-1 may prevent the photo-charges generated from the first photoelectric converter 100-1 from diffusing into the second photoelectric converter 100-2 and prevent the photo-charges generated from the second photoelectric converter 100-2 from diffusing into the first photoelectric converter 100-1. The second insulation layer 110-2 may prevent the photo-charges generated from the second photoelectric converter 100-2 from diffusing into the third photoelectric converter 100-3 and prevent the photo-charges generated from the third photoelectric converter 100-3 from diffusing into the second photoelectric converter 100-2.

The first through third photoelectric converters 100-1, 100-2, 100-3 may include first through third organic photodiodes OPD1, OPD2, OPD3, respectively.

Incident light IL may enter into the first photoelectric converter 100-1 from above the first photoelectric converter 100-1 and reach the third photoelectric converter 100-3 through the second photoelectric converter 100-2. As a wavelength of a light signal increases, a transmittance of the light signal increases. Therefore, for example, among light signals included in the incident light IL, a light signal of blue color, which has a relatively short wavelength, may reach the first photoelectric converter 100-1 while a light signal of red color, which has a relatively long wavelength, may reach the third photoelectric converter 100-3. Therefore, the first organic photodiode OPD1 may include an organic material absorbing a light signal of blue color, the second organic photodiode OPD2 may include an organic material absorbing a light signal of green color and the third organic photodiode OPD3 may include an organic material absorbing a light signal of red color. As such, the first photoelectric converter 100-1 may generate photo-charges in response to a light signal within a wavelength range of blue color and provide the photo-charges to the first storage node SN1, the second photoelectric converter 100-2 may generate photo-charges in response to a light signal within a wavelength range of green color and provide the photo-charges to the second storage node SN2 and the third photoelectric converter 100-3 may generate photo-charges in response to a light signal within a wavelength range of red color and provide the photo-charges to the third storage node SN3.

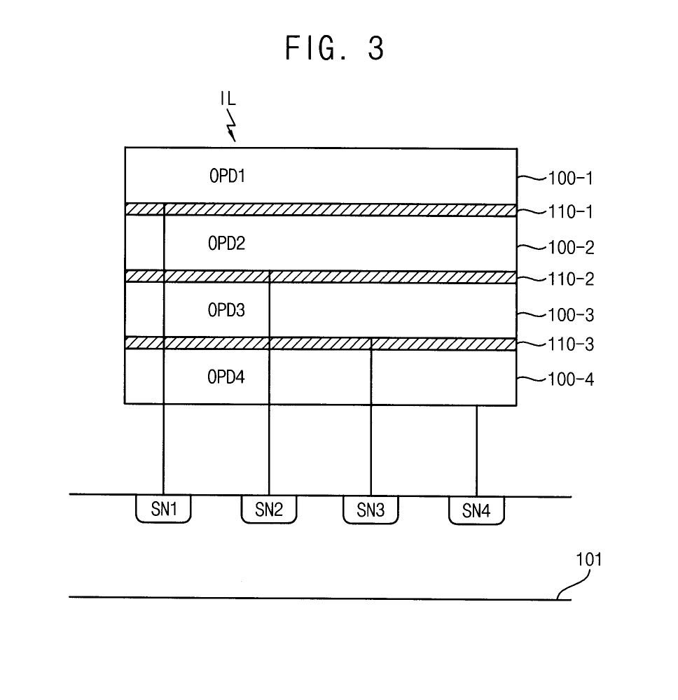

FIG. 3 is a diagram illustrating another example of photoelectric converters included in the unit pixel of FIG. 1, according to another exemplary embodiment.

Referring to FIGS. 1 and 3, the unit pixel 10 may include first through fourth photoelectric converters 100-1, 100-2, 100-3, 100-4 stacked on each other above the substrate 101 and first through fourth storage nodes SN1, SN2, SN3, SN4 formed on the substrate 101.

The first through fourth photoelectric converters 100-1, 100-2, 100-3, 100-4 may be electrically connected to the first through fourth storage nodes SN1, SN2, SN3, SN4 respectively, through wirings.

A first insulation layer 110-1 may be formed between the first photoelectric converter 100-1 and the second photoelectric converter 100-2, a second insulation layer 110-2 may be formed between the second photoelectric converter 100-2 and the third photoelectric converter 100-3 and a third insulation layer 110-3 may be formed between the third photoelectric converter 100-3 and the fourth photoelectric converter 100-4. The first insulation layer 110-1 may prevent the photo-charges generated from the first photoelectric converter 100-1 from diffusing into the second photoelectric converter 100-2 and prevent the photo-charges generated from the second photoelectric converter 100-2 from diffusing into the first photoelectric converter 100-1. The second insulation layer 110-2 may prevent the photo-charges generated from the second photoelectric converter 100-2 from diffusing into the third photoelectric converter 100-3 and prevent the photo-charges generated from the third photoelectric converter 100-3 from diffusing into the second photoelectric converter 100-2. The third insulation layer 110-3 may prevent the photo-charges generated from the third photoelectric converter 100-3 from diffusing into the fourth photoelectric converter 100-4 and prevent the photo-charges generated from the fourth photoelectric converter 100-4 from diffusing into the third photoelectric converter 100-3.

The first through fourth photoelectric converters 100-1, 100-2, 100-3, 100-4 may include first through fourth organic photodiodes OPD1, OPD2, OPD3, OPD4, respectively.

Incident light IL may enter into the first photoelectric converter 100-1 from above the first photoelectric converter 100-1 and reach the fourth photoelectric converter 100-4 through the second photoelectric converter 100-2 and the third photoelectric converter 100-3. As the wavelength of the light signal increases, the transmittance of the light signal increases. Therefore, for example, among light signals included in the incident light IL, a light signal of blue color, which has a relatively short wavelength, may reach the first photoelectric converter 100-1 while a light signal of infrared rays, which has a relatively long wavelength, may reach the fourth photoelectric converter 100-4. Therefore, the first organic photodiode OPD1 may include an organic material absorbing a light signal of blue color, the second organic photodiode OPD2 may include an organic material absorbing a light signal of green color, the third organic photodiode OPD3 may include an organic material absorbing a light signal of red color and the fourth organic photodiode OPD4 may include an organic material absorbing a light signal of infrared rays. As such, the first photoelectric converter 100-1 may generate photo-charges in response to a light signal within a wavelength range of blue color and provide the photo-charges to the first storage node SN1, the second photoelectric converter 100-2 may generate photo-charges in response to a light signal within a wavelength range of green color and provide the photo-charges to the second storage node SN2, the third photoelectric converter 100-3 may generate photo-charges in response to a light signal within a wavelength range of red color and provide the photo-charges to the third storage node SN3 and the fourth photoelectric converter 100-4 may generate photo-charges in response to a light signal within a wavelength range of infrared rays and provide the photo-charges to the fourth storage node SN4.

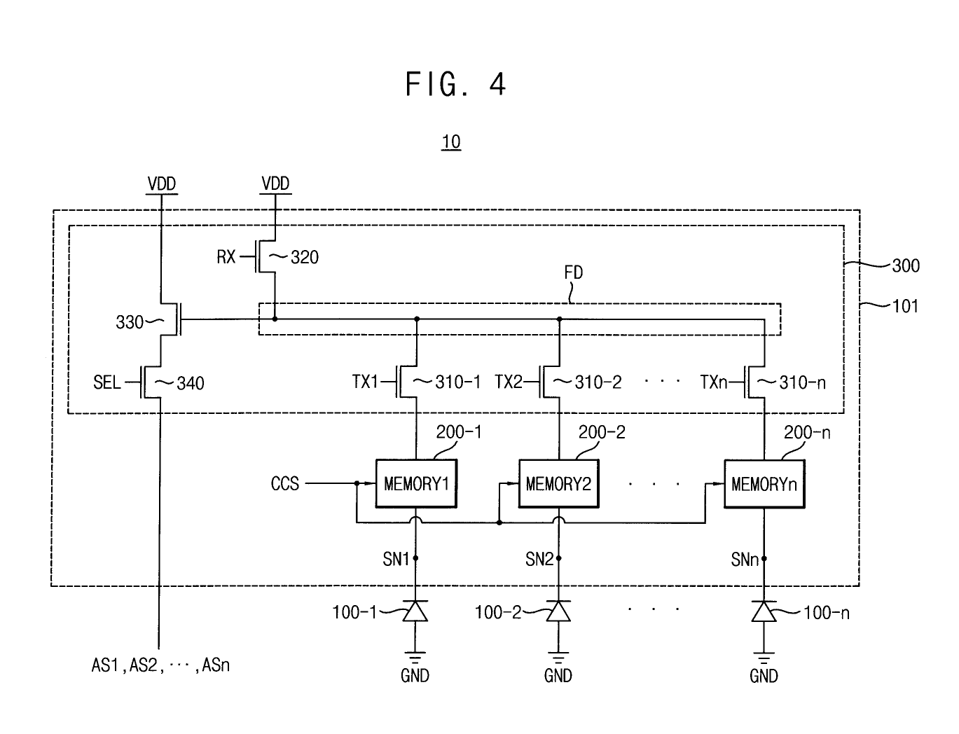

FIG. 4 is a circuit diagram illustrating an example of a signal generator included in the unit pixel of FIG. 1.

Referring to FIGS. 1 and 4, the signal generator 300 may include first through n-th transmission transistors 310-1, 310-2, . . . , 310-n, a reset transistor 320, a driving transistor 330 and a row selection transistor 340.

A k-th transmission transistor 310-k may include a source coupled to the k-th memory 200-k, a drain coupled to a floating diffusion area FD and a gate receiving a k-th transmission control signal TXk. Here, k represents a positive integer equal to or smaller than n.

The reset transistor 320 may include a source coupled to the floating diffusion area FD, a drain coupled to a supply voltage VDD and a gate receiving a reset control signal RX.

The driving transistor 330 may include a source coupled a drain of the row selection transistor 340, a drain coupled to the supply voltage VDD and a gate coupled to the floating diffusion area FD.

The row selection transistor 340 may include a drain coupled to the source of the driving transistor 330, a gate receiving a row selection signal SEL and a source outputting the first through n-th analog signals AS1, AS2, . . . , ASn.

The first through n-th transmission control signals TX1, TX2, . . . , TXn may be activated consecutively. Therefore, the first through n-th transmission transistors 310-1, 310-2, . . . , 310-n may be consecutively turned on in response to the first through n-th transmission control signals TX1, TX2, . . . , TXn to consecutively transfer the photo-charges stored in the first through n-th memories 200-1, 200-2, . . . , 200-n to the floating diffusion area FD.

The reset control signal RX and each of the first through n-th transmission control signals TX1, TX2, . . . , TXn may be activated alternately. Therefore, the reset transistor 320 and each of the first through n-th transmission transistors 310-1, 310-2, . . . , 310-n may be turned on alternately.

For example, the signal generator 300 may turn on the first transmission transistor 310-1 to transfer the photo-charges stored in the first memory 200-1 to the floating diffusion area FD and generate the first analog signal AS1 based on an amount of the photo-charges transferred to the floating diffusion area FD. After that, the signal generator 300 may turn on the reset transistor 320 to reset the floating diffusion area FD. After that, the signal generator 300 may turn on the second transmission transistor 310-2 to transfer the photo-charges stored in the second memory 200-2 to the floating diffusion area FD and generate the second analog signal AS2 based on an amount of the photo-charges transferred to the floating diffusion area FD. In this way, the signal generator 300 may generate the first through n-th analog signals AS1, AS2, . . . , ASn consecutively based on the photo-charges stored in the first through n-th memories 200-1, 200-2, . . . , 200-n, respectively.

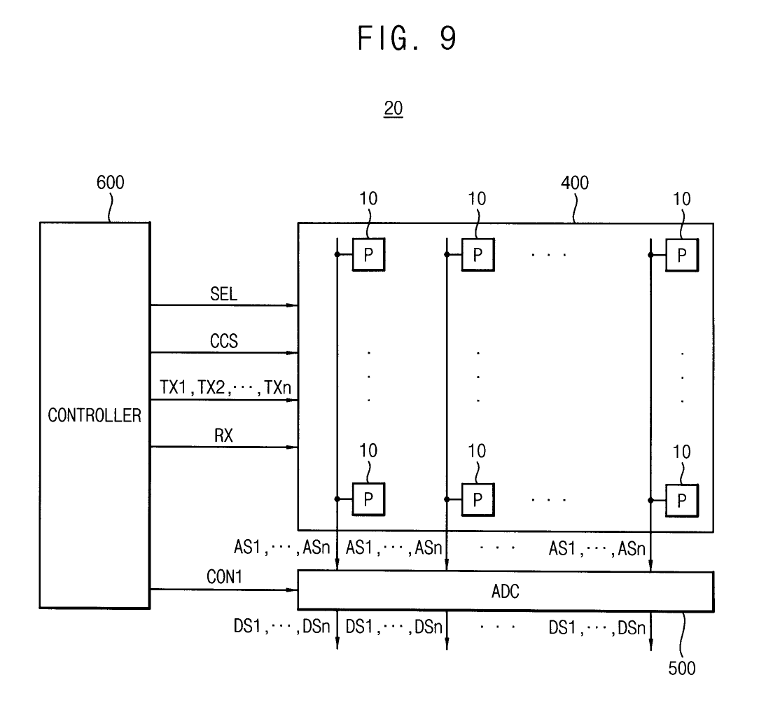

As will be described below with reference to FIG. 9, the first through n-th transmission control signals TX1, TX2, . . . , TXn, the reset control signal RX and the row selection signal SEL may be provided from a controller of an image sensor including the unit pixel 10. An operation of the unit pixel 10 will be described below with reference to FIG. 9.

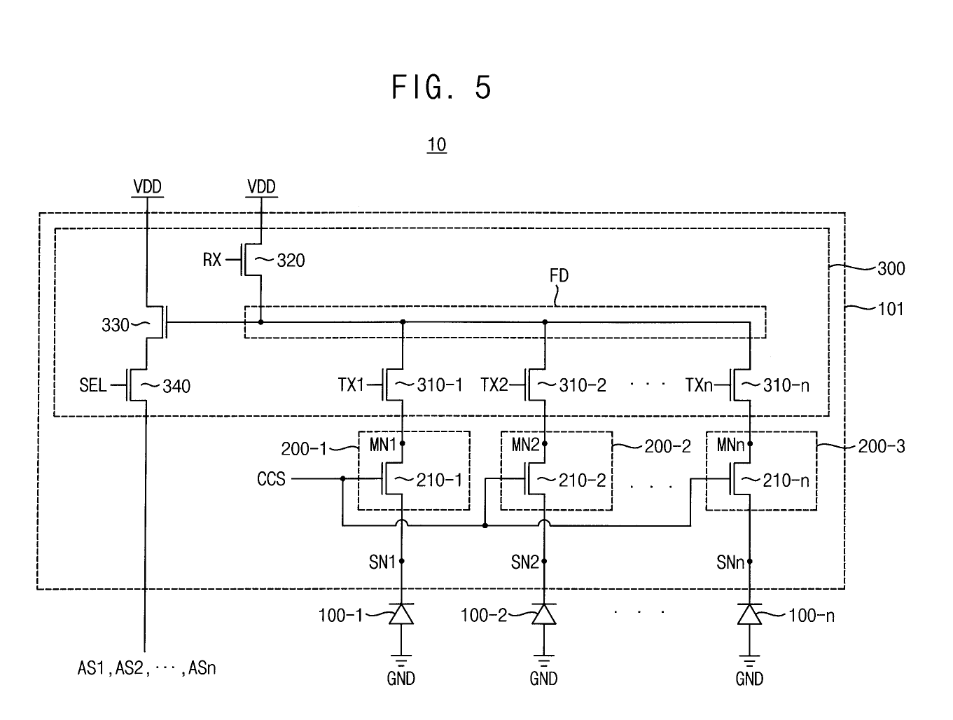

FIG. 5 is a circuit diagram illustrating an example of memories included in the unit pixel of FIG. 1, according to an exemplary embodiment.

Referring to FIG. 5, the n-th memory 200-n may include an n-th storage transistor 210-n having a source coupled to the n-th storage node SNn, a drain corresponding to an n-th memory node MNn and a gate receiving the common control signal CCS.

As illustrated in FIG. 5, since the common control signal CCS is commonly applied to the gates of the first through n-th storage transistors 210-1, 210-2, . . . , 210-n, the first through n-th storage transistors 210-1, 210-2, . . . , 210-n may be turned on at the same time in response to the common control signal CCS to concurrently transfer the photo-charges accumulated in the first through n-th storage nodes SN1, SN2, . . . , SNn to the first through n-th memory nodes MN1, MN2, . . . , MNn, respectively. Therefore, the first through n-th memories 200-1, 200-2, . . . , 200-n may store the photo-charges provided from the first through n-th storage nodes SN1, SN2, . . . , SNn in the first through n-th memory nodes MN1, MN2, . . . , MNn, respectively.

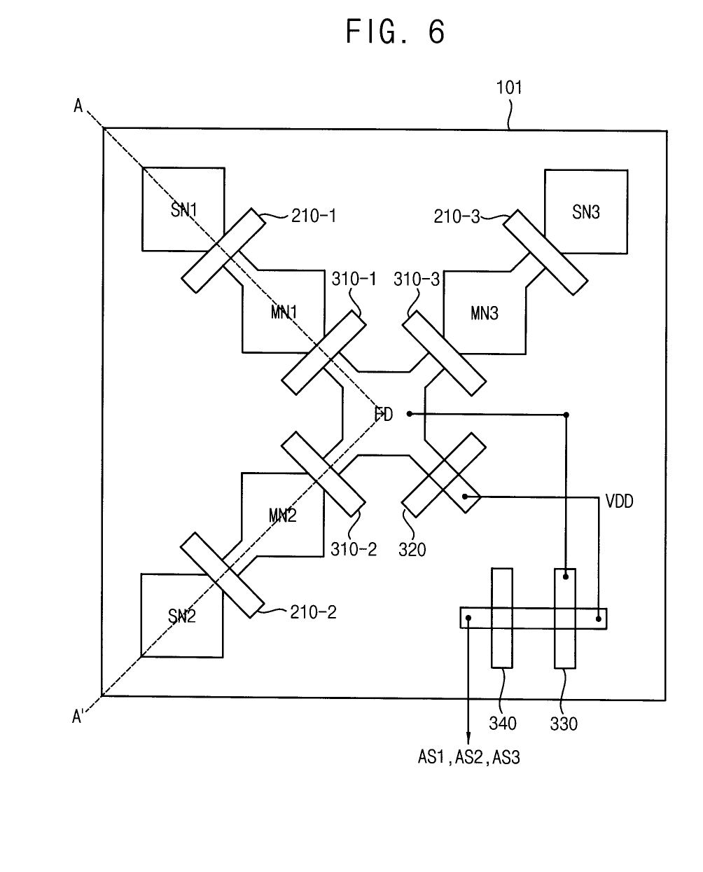

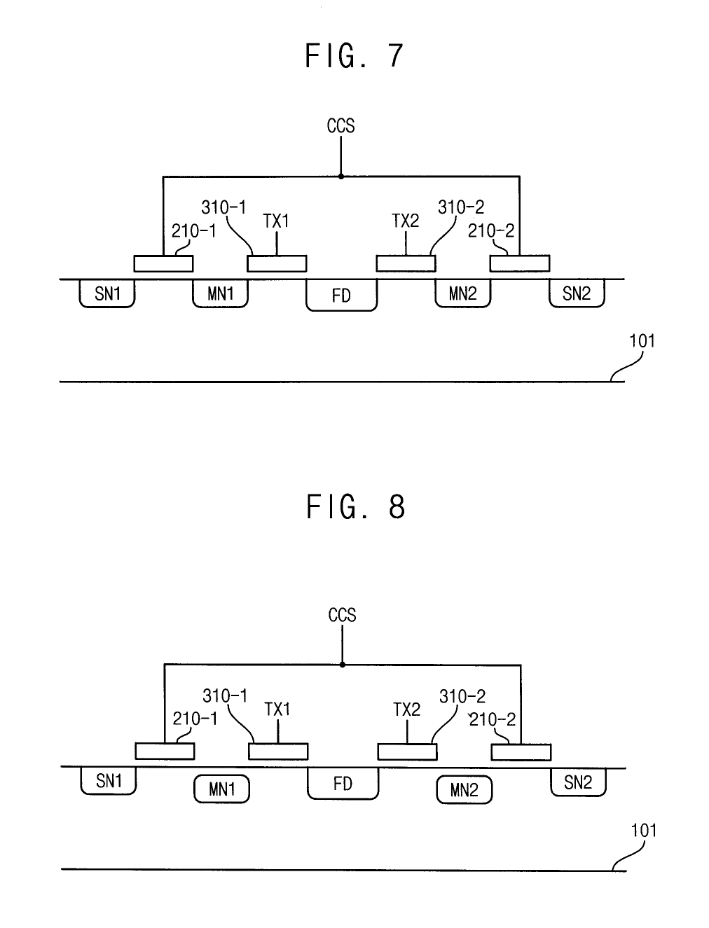

FIG. 6 is a plane diagram illustrating an example of a substrate on which a signal generator and memories included in the unit pixel of FIG. 5 are formed, according to an exemplary embodiment. FIG. 7 is a cross-sectional view of the substrate of FIG. 6 taken along line A-A′. FIG. 8 is another cross-sectional view of the substrate of FIG. 6 taken along line A-A′.

Hereinafter, the unit pixel 10 will be described to include the first through third photoelectric converters 100-1, 100-2, 100-3, as illustrated in FIG. 2, as an example. However, the structure of the unit pixel 10 is not limited thereto, and the unit pixel 10 may include another number of the photoelectric converters.

Referring to FIGS. 5, 6, 7 and 8, the floating diffusion area FD may be formed on the substrate 101, and the first through third storage nodes SN1, SN2, SN3 may be formed around the floating diffusion area FD to be spaced apart from each other. The first memory node MN1 may be formed between the first storage node SN1 and the floating diffusion area FD, the second memory node MN2 may be formed between the second storage node SN2 and the floating diffusion area FD and the third memory node MN3 may be formed between the third storage node SN3 and the floating diffusion area FD.

As described above with reference to FIGS. 2, 4 and 6, the first through third storage nodes SN1, SN2, SN3 may be electrically connected to the first through third photoelectric converters 100-1, 100-2, 100-3, which are stacked on each other above the substrate 101, respectively, through wirings.

The first storage transistor 210-1 may be formed between the first storage node SN1 and the first memory node MN1, the second storage transistor 210-2 may be formed between the second storage node SN2 and the second memory node MN2, and the third storage transistor 210-3 may be formed between the third storage node SN3 and the third memory node MN3. The first through third storage transistors 210-1, 210-2, 210-3 may be turned on at the same time in response to the common control signal CCS to concurrently transfer the photo-charges accumulated in the first through third storage nodes SN1, SN2, SN3 to the first through third memory nodes MN1, MN2, MN3, respectively.

The first transmission transistors 310-1 may be formed between the first memory node MN1 and the floating diffusion area FD, the second transmission transistors 310-2 may be formed between the second memory node MN2 and the floating diffusion area FD, and the third transmission transistors 310-3 may be formed between the third memory node MN3 and the floating diffusion area FD.

The first through third transmission transistors 310-1, 310-2, 310-3 may be consecutively turned on in response to the first through third transmission control signals TX1, TX2, TX3, which are activated consecutively, to consecutively transfer the photo-charges stored in the first through third memories 200-1, 200-2, 200-3 to the floating diffusion area FD.

The reset transistor 320 may be formed between the floating diffusion area FD and the supply voltage VDD. The reset transistor 320 may be turned on in response to the reset control signal RX such that reset transistor 320 may discharge the photo-charges stored in the floating diffusion area FD into the supply voltage VDD to initialize a voltage of the floating diffusion area FD to the supply voltage VDD.

The driving transistor 330 may be formed between the supply voltage VDD and the row selection transistor 340, and the gate of the driving transistor 330 may be coupled to the floating diffusion area FD. Therefore, when the row selection transistor 340 is turned on in response to the row selection signal SEL, the first through n-th analog signals AS1, AS2, . . . , ASn having a magnitude corresponding to an amount of the photo-charges stored in the floating diffusion area FD may be output through the source of the row selection transistor 340.

In some example embodiments, as illustrated in FIG. 7, the floating diffusion area FD, the first through third storage nodes SN1, SN2, SN3 and the first through third memory nodes MN1, MN2, MN3 may be formed on a surface of the substrate 101. Therefore, the first through third storage nodes SN1, SN2, SN3 may be easily connected to the first through third photoelectric converters 100-1, 100-2, 100-3 stacked on each other above the substrate 101 through wirings, and the floating diffusion area FD may be easily connected to the gate of the driving transistor 330 through wirings.

In other example embodiments, as illustrated in FIG. 8, the floating diffusion area FD and the first through third storage nodes SN1, SN2, SN3 may be formed on a surface of the substrate 101, and the first through third memory nodes MN1, MN2, MN3 may be formed in the substrate 101 apart from the surface of the substrate 101. In this case, thermal charges generated on the surface of the substrate 101 may be prevented from entering into the first through third memory nodes MN1, MN2, MN3. As such, noise of the unit pixel 10 may be reduced.

In a multi-layer image sensor, if analog signals generated from a unit pixel represent image information at different times, noise may be included in the image data generated from the image sensor such that a quality of the image data may be degraded.

As described above with reference to FIGS. 1 to 8, the unit pixel 10 includes the first through n-th memories 200-1, 200-2, . . . , 200-n. Therefore, the photo-charges generated from the first through n-th photoelectric converters 100-1, 100-2, . . . , 100-n and accumulated in respective ones of the first through n-th storage nodes SN1, SN2, . . . , SNn may be transferred to respective ones of the first through n-th memories 200-1, 200-2, . . . , 200-n at the same time in response to the common control signal CCS. After that, the signal generator 300 may generate the first through n-th analog signals AS1, AS2, . . . , ASn consecutively based on the photo-charges stored in the first through n-th memories 200-1, 200-2, . . . , 200-n, respectively. Therefore, the first through n-th analog signals AS1, AS2, . . . , ASn generated from the unit pixel 10 may represent image information at the same time. As such, the image sensor including the unit pixel 10 may provide a high quality image.

FIG. 9 is a block diagram illustrating an image sensor according to an exemplary embodiment.

Referring to FIG. 9, an image sensor 20 includes a pixel array 400, an analog-digital converter ADC 500 and a controller 600.

The pixel array 400 includes a plurality of unit pixels P 10 arranged in rows and columns. Each of the plurality of unit pixels 10 generates first through n-th analog signals AS1, AS2, . . . , ASn consecutively by detecting light signals within different wavelength ranges from a same start time to a same end time.

The analog-digital converter 500 converts the first through n-th analog signals AS1, AS2, . . . , ASn provided from each of the plurality of unit pixels 10 to first through n-th digital signals DS1, DS2, . . . , DSn, respectively.

The controller 600 controls an operation of the pixel array 400 using the row selection signal SEL, the reset control signal RX, the common control signal CCS, and the first through n-th transmission control signals TX1, TX2, . . . , TXn, and controls an operation of the analog-digital converter ADC 500 using a control signal CON1.

In some example embodiments, each of the plurality of unit pixels 10 included in the image sensor 20 of FIG. 9 may be implemented with the unit pixel 10 of FIG. 1.

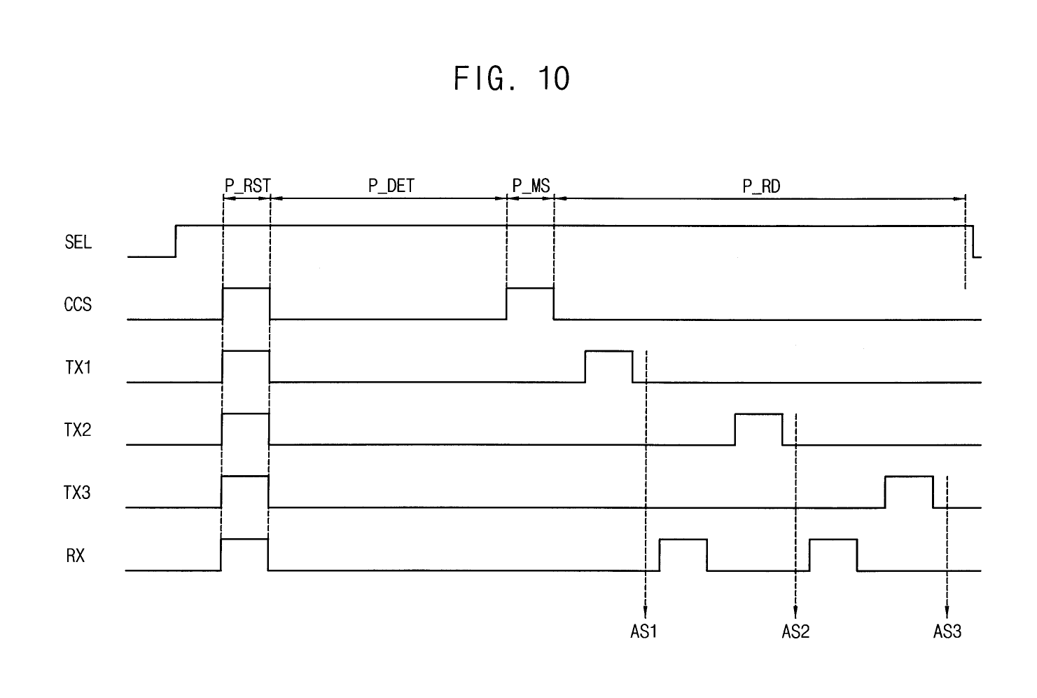

FIG. 10 is an example of a timing diagram for describing an operation of an image sensor of FIG. 9.

As an example, FIG. 10 shows a timing diagram when each of the plurality of unit pixels 10 includes the first through third photoelectric converters 100-1, 100-2, 100-3, as illustrated in FIG. 2. However, the structure of the unit pixel 10 is not limited thereto, and the unit pixel 10 may include another number of the photoelectric converters.

Hereinafter, an operation of the image sensor 20 will be described with reference to FIGS. 1 to 10.

Each of the first through n-th photoelectric converters 100-1, 100-2, . . . , 100-n included in the unit pixel 10 may continuously generate photo-charges in response to a light signal within a respective wavelength range and provides the photo-charges to first through n-th storage nodes SN1, SN2, . . . , SNn, respectively.

The controller 600 may control the operation of the pixel array 400 by a unit of a row by providing the row selection signal SEL, the reset control signal RX, the common control signal CCS, and the first through n-th transmission control signals TX1, TX2, . . . , TXn to the pixel array 400.

As illustrated in FIG. 10, the controller 600 may select one of rows included in the pixel array 400 by providing an activated row selection signal SEL to the selected row of the pixel array 400 to turn on the row selection transistor 340.

In a reset phase P_RST, the controller 600 may provide an activated reset control signal RX, activated first through n-th transmission control signals TX1, TX2, . . . , TXn and activated common control signal CCS to the selected row to turn on the reset transistor 320, the first through n-th transmission transistors 310-1, 310-2, . . . , 310-n and the first through n-th storage transistors 210-1, 210-2, . . . , 210-n. Therefore, the photo-charges stored in the first through n-th storage nodes SN1, SN2, . . . , SNn, the first through n-th memory nodes MN1, MN2, . . . , MNn and the floating diffusion area FD may be discharged to the supply voltage VDD through the reset transistor 320 such that a voltage of the floating diffusion area FD may be initialized to the supply voltage VDD.

In a detection phase P_DET, the controller 300 may deactivate the reset control signal RX, the first through n-th transmission control signals TX1, TX2, . . . , TXn and the common control signal CCS to turn off the reset transistor 320, the first through n-th transmission transistors 310-1, 310-2, . . . , 310-n and the first through n-th storage transistors 210-1, 210-2, . . . , 210-n. Therefore, the photo-charges generated from the first through n-th photoelectric converters 100-1, 100-2, . . . , 100-n included in the unit pixel 10 may be accumulated in the first through n-th storage nodes SN1, SN2, . . . , SNn, respectively.

In a memory storage phase P_MS, the controller 300 may activate the common control signal CCS and keep the reset control signal RX and the first through n-th transmission control signals TX1, TX2, . . . , TXn deactivated to turn on the first through n-th storage transistors 210-1, 210-2, . . . , 210-n while maintaining the reset transistor 320 and the first through n-th transmission transistors 310-1, 310-2, . . . , 310-n in a turned off state. Therefore, the photo-charges stored in the first through n-th storage nodes SN1, SN2, . . . , SNn may be transferred to the first through n-th memory nodes MN1, MN2, . . . , MNn, respectively, at the same time. As such, an amount of the photo-charges stored in each of the first through n-th memory nodes MN1, MN2, . . . , MNn may correspond to an amount of the photo-charges generated from each of the first through n-th photoelectric converters 100-1, 100-2, . . . , 100-n, respectively, in response to a light signal received from the same start time to the same end time.

In a read phase P_RD, the controller 600 may deactivate the common control signal CCS and alternately activate the reset control signal RX and each of the first through n-th transmission control signals TX1, TX2, . . . , TXn.

For example, as illustrated in FIG. 10, the controller 600 may activate the first transmission control signal TX1 to turn on the first transmission transistor 310-1 such that the photo-charges stored in the first memory node MN1 may be transferred to the floating diffusion area FD. Therefore, a voltage of the floating diffusion area FD, which is a voltage of the gate of the driving transistor 330, may be changed in response to an amount of the photo-charges transferred to the floating diffusion area FD. Since the row selection transistor 340 is turned on in response to the activated row selection signal SEL, the first analog signal AS1 having a magnitude corresponding to the voltage of the floating diffusion area FD may be output through the source of the row selection transistor 340. After that, the controller 600 may activate the reset control signal RX to turn on the reset transistor 320 such that the photo-charges stored in the floating diffusion area FD may be discharged to the supply voltage VDD through the reset transistor 320. Therefore, the voltage of the floating diffusion area FD may be initialized to the supply voltage VDD. After that, the controller 600 may activate the second transmission control signal TX2 to turn on the second transmission transistor 310-2 such that the photo-charges stored in the second memory node MN2 may be transferred to the floating diffusion area FD. Therefore, the second analog signal AS2 having a magnitude corresponding to the voltage of the floating diffusion area FD may be outputted through the source of the row selection transistor 340. After that, the controller 600 may activate the reset control signal RX to turn on the reset transistor 320 such that the photo-charges stored in the floating diffusion area FD may be discharged to the supply voltage VDD through the reset transistor 320. Therefore, the voltage of the floating diffusion area FD may be initialized to the supply voltage VDD. In this way, the controller 600 may activate each of the first through n-th transmission control signals TX1, TX2, . . . , TXn and the reset control signal RX alternately such that the first through n-th analog signals AS1, AS2, . . . , ASn may be generated consecutively based on an amount of the photo-charges stored in the first through n-th memories 200-1, 200-2, . . . , 200-n, respectively.

The controller 300 may deactivate the row selection signal SEL after the first through n-th analog signals AS1, AS2, . . . , ASn are output.

The controller 600 may repeat above described operations for each row. Therefore, the pixel array 400 may consecutively generate the first through n-th analog signals AS1, AS2, . . . , ASn row by row.

The analog-digital converter ADC 500 may convert the first through n-th analog signals AS1, AS2, . . . , ASn provided from each of the plurality of unit pixels 10 to the first through n-th digital signals DS1, DS2, . . . , DSn, respectively.

In some example embodiments, the analog-digital converter ADC 500 may generate the first through n-th digital signals DS1, DS2, . . . , DSn by performing a single slope analog-digital conversion on the first through n-th analog signals AS1, AS2, . . . , ASn, respectively. In this case, the controller 600 may provide a ramp signal and a count clock signal to the analog-digital converter ADC 500. In other example embodiments, the analog-digital converter ADC 500 may generate the first through n-th digital signals DS1, DS2, . . . , DSn by performing a sigma-delta analog-digital conversion on the first through n-th analog signals AS1, AS2, . . . , ASn, respectively. According to example embodiments, the analog-digital converter ADC 500 may generate the first through n-th digital signals DS1, DS2, . . . , DSn by performing various kinds of analog-digital conversions on the first through n-th analog signals AS1, AS2, . . . , ASn, respectively.

As described above with reference to FIGS. 1 to 10, the unit pixel 10 may consecutively generate the first through n-th analog signals AS1, AS2, . . . , ASn, which represent image information acquired and transferred to the plurality of memories MN1, MN2, . . . , MNn at the same time, and the analog-digital converter ADC 500 may generate the first through n-th digital signals DS1, DS2, . . . , DSn by performing an analog-digital conversion on the first through n-th analog signals AS1, AS2, . . . , ASn, respectively. Therefore, the image sensor 20 may provide a high quality image data.

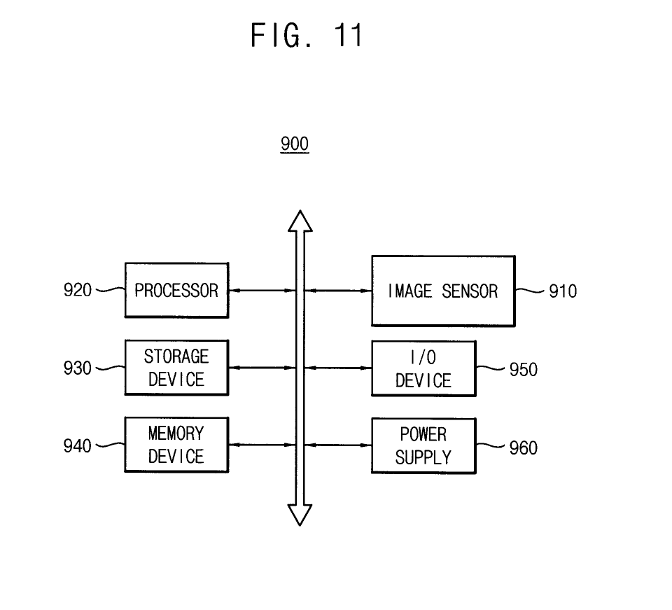

FIG. 11 is a block diagram illustrating a computing system including an image sensor according to an exemplary embodiment.

Referring to FIG. 11, a computing system 900 may include an image sensor 910, a processor 920 and a storage device 930.

The image sensor 910 may generate a digital signal corresponding to incident light. In some example embodiments, the image sensor 910 may be a multi-layer image sensor. For example, the image sensor 910 may include a pixel array having a plurality of unit pixels and an analog-digital converter. Each of the plurality of unit pixels may generate first through n-th analog signals consecutively by detecting light signals within different wavelength ranges from a same start time to a same end time. The analog-digital converter may convert the first through n-th analog signals to the first through n-th digital signals.

The image sensor 910 may be embodied with the image sensor 20 of FIG. 9. A structure and an operation of the image sensor 20 of FIG. 9 are described above with reference to FIGS. 1 to 10. Therefore, a detail description of the image sensor 910 will be omitted.

The storage device 930 may store the digital signal generated from the image sensor 910. The processor 920 may control operations of the image sensor 910 and the storage device 930.

The computing system 900 may further include a memory device 940, an input/output (I/O) device 950 and a power supply 960. Although it is not illustrated in FIG. 11, the computing system 900 may further include ports that communicate with a video card, a sound card, a memory card, a universal serial bus (USB) device, and/or other electronic devices.

The processor 920 may perform various calculations or tasks. According to some embodiments, the processor 920 may be a microprocessor or a central processing unit (CPU). The processor 920 may communicate with the storage device 930, the memory device 940 and the I/O device 950 via an address bus, a control bus, and/or a data bus. In some example embodiments, the processor 920 may be coupled to an extended bus, such as a peripheral component interconnection (PCI) bus.

The storage device 930 may include a non-volatile memory device such as a flash memory device, a solid state drive (SSD), a hard disk drive (HDD), and/or a compact disk read-only memory (CD-ROM) drive, etc.

The memory device 940 may store data used for an operation of the electronic device 900. The memory device 940 may be a dynamic random access memory (DRAM), a static random access memory (SRAM), or a non-volatile memory, such as an erasable programmable read-only memory (EPROM), an electrically erasable programmable read-only memory (EEPROM), a flash memory, etc.

The I/O device 950 may include a touch screen, a keypad, a keyboard, a mouse, a printer, and/or a display device, etc. The power supply 960 may supply operational power.

The image sensor 910 may be connected to the processor 920 through one or more of the above buses or other communication links to communicate with the processor 920.

The image sensor 910 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi-chip package (MCP), wafer-level fabricated package (WFP), or wafer-level processed stack package (WSP).

According to example embodiments, the image sensor 910 may be integrated with the processor 920 in one chip, or the image sensor 910 and the processor 920 may be implemented as separate chips.

The computing system 900 may be any computing system using an image sensor. For example, the computing system 900 may include a digital camera, a mobile phone, a smart phone, a portable multimedia player (PMP), and/or a personal digital assistant (PDA), etc.

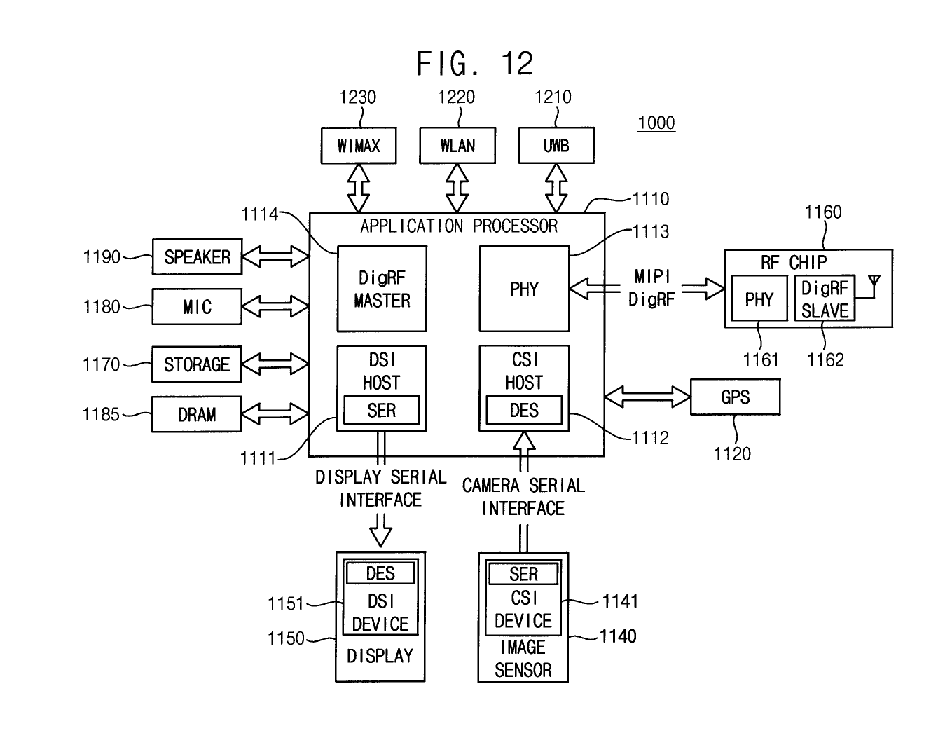

FIG. 12 is a block diagram illustrating an example of an interface used in the computing system of FIG. 11.

Referring to FIG. 12, a computing system 1000 may be implemented by a data processing device (e.g., a cellular phone, a personal digital assistant, a portable multimedia player, and/or a smart phone, etc.) that uses or supports a mobile industry processor interface (MIPI) interface. The computing system 1000 may include an application processor 1110, an image sensor 1140, and/or a display device 1150, etc.

A camera serial interface (CSI) host 1112 of the application processor 1110 may perform serial communication with a CSI device 1141 of the image sensor 1140 via a camera serial interface (CSI). In some embodiments, the CSI host 1112 may include a deserializer (DES), and the CSI device 1141 may include a serializer (SER). A digital serial interface (DSI) host 1111 of the application processor 1110 may perform a serial communication with a DSI device 1151 of the display device 1150 via a display serial interface (DSI). In some example embodiments, the DSI host 1111 may include a serializer (SER), and the DSI device 1151 may include a deserializer (DES).

The computing system 1000 may further include a radio frequency (RF) chip 1160 performing a communication with the application processor 1110. A physical layer (PHY) 1113 of the computing system 1000 and a physical layer (PHY) 1161 of the RF chip 1160 may perform data communications based on a MIPI DigRF. The application processor 1110 may further include a DigRF MASTER 1114 that controls the data communications according to the MIPI DigRF of the PHY 1161, and the RF chip 1160 may further include a DigRF SLAVE 1162 controlled by the DigRF MASTER 1114.

The computing system 1000 may further include a global positioning system (GPS) 1120, a storage 1170, a MIC 1180, a DRAM device 1185, and a speaker 1190. In addition, the computing system 1000 may perform communications using an ultra wideband (UWB) 1210, a wireless local area network (WLAN) 1220, a worldwide interoperability for microwave access (WIMAX) 1230, etc. However, the structure and the interface of the computing system 1000 are not limited thereto.

The foregoing is illustrative of the present inventive concept and is not to be construed as limiting thereof. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A unit pixel of an image sensor, the unit pixel comprising:
first through n-th photoelectric converters stacked on each other, and configured to generate photo-charges in response to light signals within respective wavelength ranges and provide the photo-charges to first through n-th storage nodes, respectively, n being an integer equal to or greater than two;
first through n-th memories configured to concurrently receive and store the photo-charges from the first through n-th storage nodes, respectively, in response to a common control signal; and
a signal generator configured to generate first through n-th analog signals consecutively based on the photo-charges stored in the first through n-th memories, respectively.

2. The unit pixel of claim 1, wherein the first through n-th memories and the signal generator are formed on a substrate and the first through n-th photoelectric converters are formed above the substrate.

3. The unit pixel of claim 2, wherein each of the first through n-th photoelectric converters comprises an organic photodiode having an organic material.

4. The unit pixel of claim 1, wherein n is equal to three or more,
the first photoelectric converter is configured to generate the photo-charges in response to a light signal within a wavelength range of blue color and provide the photo-charges to the first storage node,
the second photoelectric converter is configured to generate the photo-charges in response to a light signal within the wavelength range of green color and provide the photo-charges to the second storage node, and
the third photoelectric converter is configured to generate the photo-charges in response to a light signal within a wavelength range of red color and provide the photo-charges to the third storage node.

5. The unit pixel of claim 4, wherein n is equal to four or more, and the fourth photoelectric converter is configured to generate the photo-charges in response to a light signal within a wavelength range of infrared rays and provide the photo-charges to the fourth storage node.

6. The unit pixel of claim 1, wherein a k-th memory includes a k-th storage transistor comprising a source coupled to a k-th storage node, a drain corresponding to a k-th memory node and a gate configured to receive the common control signal, where k is a positive integer equal to or smaller than n.

7. The unit pixel of claim 6, wherein k is equal to n, and the first through n-th storage transistors included in the first through n-th memories, respectively, are configured to turn on at a same time in response to the common control signal to concurrently transfer the photo-charges stored in the first through n-th storage nodes to first through n-th memory nodes, respectively.

8. The unit pixel of claim 1, wherein the signal generator comprises:
first through n-th transmission transistors configured to transfer the photo-charges stored in the first through n-th memories, respectively, to a floating diffusion area in response to first through n-th transmission control signals, respectively;
a reset transistor comprising a source coupled to the floating diffusion area, a drain coupled to a supply voltage and a gate configured to receive a reset control signal;
a driving transistor comprising a source, a drain coupled to the supply voltage and a gate coupled to the floating diffusion area; and
a row selection transistor comprising a drain coupled to the source of the driving transistor, a gate configured to receive a row selection signal and a source configured to output the first through n-th analog signals.

9. The unit pixel of claim 8, wherein a k-th transmission transistor comprises a source coupled to a k-th memory, a drain coupled to the floating diffusion area and a gate configured to receive a k-th transmission control signal, where k is a positive integer equal to or smaller than n.

10. The unit pixel of claim 8, wherein k is equal to n, and the first through n-th transmission control signals are activated consecutively.

11. The unit pixel of an image sensor of claim 10, wherein the reset control signal and each of the first through n-th transmission control signals are activated alternately.

12. An image sensor comprising:
a pixel array comprising a plurality of unit pixels arranged in rows and columns, wherein each of the plurality of unit pixels is configured to generate first through n-th analog signals consecutively by detecting light signals within different wavelength ranges from a same start time to a same end time;
an analog-digital converter configured to convert the first through n-th analog signals to first through n-th digital signals, respectively; and
a controller configured to control operations of the pixel array and the analog-digital converter.

13. The image sensor of claim 12, wherein each of the plurality of unit pixels comprises:
first through n-th photoelectric converters stacked on each other, wherein each of the first through n-th photoelectric converters is configured to generate photo-charges in response to a light signal within a wavelength range and provide the photo-charges to first through n-th storage nodes, respectively, n being an integer equal to or greater than two;
first through n-th memories configured to concurrently receive and store the photo-charges from the first through n-th storage nodes, respectively, in response to a common control signal; and
a signal generator configured to generate the first through n-th analog signals consecutively based on the photo-charges stored in the first through n-th memories, respectively.

14. The image sensor of claim 13, wherein the signal generator comprises:
first through n-th transmission transistors configured to transfer the photo-charges stored in the first through n-th memory nodes, respectively, to a floating diffusion area in response to first through n-th transmission control signals, respectively;
a reset transistor comprising a source coupled to the floating diffusion area, a drain coupled to a supply voltage and a gate configured to receive a reset control signal;
a driving transistor comprising a source, a drain coupled to the supply voltage and a gate coupled to the floating diffusion area; and
a row selection transistor comprising a drain coupled to the source of the driving transistor, a gate configured to receive a row selection signal and a source configured to output the first through n-th analog signals.

15. The image sensor of claim 14, wherein the controller is configured to activate the common control signal, the first through n-th transmission control signals and the reset control signal in a reset phase, deactivate the common control signal in a detection phase, activate the common control signal and deactivates the first through n-th transmission control signals in a memory storage phase, and activate each of the first through n-th transmission control signals and the reset control signal alternately in a read phase.

16. A unit pixel comprising:
a plurality of photoelectric converters configured to generate photo-charges in response to light signals of different wavelengths and provide the generated photo-charges to a plurality of storage nodes, respectively;
a plurality of memories configured to concurrently receive and store the photo-charges from the plurality of storage nodes, respectively, in response to a common control signal; and
a signal generator configured to generate a plurality of analog signals based on the photo-charges stored in the plurality of memories, respectively.

17. The unit pixel of claim 16, wherein the different wavelengths comprise a wavelength of a blue color, a wavelength of a green color, and a wavelength of a red color.

18. The unit pixel of claim 17, wherein the different wavelengths further comprises an infrared wavelength.

19. The unit pixel of claim 16, further comprising a substrate,
wherein the signal generator comprises:
a plurality of transmission transistors configured to transfer the photo-charges stored in the plurality of memories, respectively, to a floating diffusion area in response to a plurality of transmission control signals, respectively;
a reset transistor comprising a source coupled to the floating diffusion area, a drain coupled to a supply voltage and a gate receiving a reset control signal;
a driving transistor comprising a source, a drain coupled to the supply voltage and a gate coupled to the floating diffusion area; and
a row selection transistor comprising a drain coupled to the source of the driving transistor, a gate configured to receive a row selection signal and a source configured to output the plurality of analog signals,
wherein the floating diffusion area, the plurality of storage nodes and the plurality of memories are formed on a surface of the substrate.

20. The unit pixel of claim 16, further comprising a substrate,
wherein the signal generator comprises:
a plurality of transmission transistors configured to transfer the photo-charges stored in the plurality of memories, respectively, to a floating diffusion area in response to a plurality of transmission control signals, respectively;
a reset transistor comprising a source coupled to the floating diffusion area, a drain coupled to a supply voltage and a gate configured to receive a reset control signal;
a driving transistor comprising a source, a drain coupled to the supply voltage and a gate coupled to the floating diffusion area; and
a row selection transistor comprising a drain coupled to the source of the driving transistor, a gate configured to receive a row selection signal and a source configured to output the plurality of analog signals,
wherein the floating diffusion area and the plurality of storage nodes are formed on a surface of the substrate, and the plurality of memories are formed in the substrate apart from the surface of the substrate.
